(19) United States
(12) Patent Application Publication
(10) Pub. No.: US 2025/0135867 A1
(43) Pub. Date: May 1, 2025

(54) WHEEL ASSEMBLY STRUCTURE OF VEHICLE

(71) Applicants: Hyundai Motor Company, Seoul (KR); Kia Corporation, Seoul (KR)

(72) Inventor: Jonghoon Lee, Hwaseong-si (KR)

(21) Appl. No.: 18/813,623

(22) Filed: Aug. 23, 2024

(30) Foreign Application Priority Data
Oct. 31, 2023 (KR) 10-2023-0148444

(51) Int. Cl. B60K 7/00; B60G 15/02; B60G 17/02; B60T 1/06; H02K 5/24; H02K 7/102; H02K 21/22

(52) U.S. Cl. CPC B60K 7/0007; B60G 15/02; B60G 17/021; B60T 1/065; H02K 5/24; H02K 7/102; H02K 21/22; B60G 2202/312; B60G 2500/30

(57) ABSTRACT

An embodiment wheel assembly structure of a vehicle includes a wheel, a tire mounted around the wheel, a rotor housing connected to the wheel, a buffer device interposed between a circumference of a central axis of the rotor housing and a central portion of the wheel or between an upper surface of the rotor housing and a lower surface of the wheel, the buffer device being configured to rotate together with the wheel and to alleviate a shock between the rotor housing and the wheel, and a stator housing fixable to the vehicle and configured to rotate the rotor housing by applying a current.

### CROSS-REFERENCE TO RELATED APPLICATIONS

This application claims the benefit of Korean Patent Application No. 10-2023-0148444, filed on Oct. 31, 2023, which application is hereby incorporated herein by reference.

### TECHNICAL FIELD

The present disclosure relates to a wheel assembly structure of a vehicle.

### BACKGROUND

An in-wheel drive system is mounted on each vehicle wheel, and in vehicles that run on electric power such as hybrid vehicles, fuel cell vehicles, and electric vehicles, is a system that generates and drives power for each vehicle wheel by installing a small individual motor on each vehicle wheel instead of using a large single motor.

The in-wheel drive system has the advantages of providing individual motors (hereinafter referred to as an in-wheel motor) for each wheel to simplify a drive system and increase an interior space compared to a vehicle equipped with a large drive motor and being able to directly control the rotation of the vehicle wheels to omit a complex power transmission device such as a differential device.

In this way, power train elements may be omitted, exhibiting high efficiency and high performance. That is, by directly installing the in-wheel motor on each vehicle wheel, it is possible to reduce power waste and secure sufficient driving power, and by maximizing the distribution of power to each in-wheel motor during driving and the recovery of braking energy due to regenerative braking when braking, it is possible to improve fuel efficiency.

However, in the in-wheel drive system, the in-wheel motor is integrated with the wheels of the vehicle, so an unsprung mass of the vehicle increases, vibration and noise (NVH) of the vehicle increase, and there is a risk of damage to the in-wheel motor due to shock on a lower portion of the vehicle. In addition, there is a problem of configuring a wheel assembly structure to ensure durability of the in-wheel motor and durability due to movement of a high-voltage cable when the wheels move.

### SUMMARY

The present disclosure relates to a wheel assembly structure of a vehicle. Particular embodiments relate to a wheel assembly structure of a vehicle including an in-wheel motor.

Embodiments of the present disclosure provide a wheel assembly structure of a vehicle capable of alleviating shock from a lower portion of the vehicle being transmitted to an in-wheel motor by providing a buffer device between the in-wheel motor and a wheel to allow displacement between the motor and the wheel and securing durability of a high-voltage cable, piping, etc., since the in-wheel motor and the vehicle do not move relative to each other.

According to an embodiment, a wheel assembly structure of a vehicle includes a wheel around which a tire of the vehicle is mounted, a rotor housing connected to the wheel and rotating with the wheel, a buffer device interposed between a circumference of a central axis of the rotor housing and a central portion of the wheel or between an upper surface of the rotor housing and a lower surface of the wheel, and rotating together when the wheel rotates and alleviating shock between the rotor housing and the wheel, and a stator housing fixed to the vehicle and rotating the rotor housing by applying a current.

The central axis of the rotor housing facing an inner side of the vehicle may be provided with a rotor brake disc.

The stator housing may be provided with a caliper that contacts the rotor brake disc and brakes the vehicle by applying frictional force to the rotor housing.

The stator housing facing the inner side of the vehicle may be provided with a vehicle connection part to connect the stator housing to the vehicle, and the stator housing and the rotor housing may not move relative to each other up and down and left and right.

An inner surface of the rotor housing facing a rotation axis of the rotor housing may be provided with a permanent magnet, and an outer surface of the stator housing at a position facing the permanent magnet may be provided with a coil, so the rotor housing operates to rotate by electromagnetic force generated by applying power to the coil.

The central portion of the wheel may be further provided with a wheel hub extending toward the inner side of the vehicle.

A shock absorber may be further provided between an upper surface of the wheel hub and a lower surface of the stator housing to alleviate the shock between the stator housing and the wheel.

An upper end of the shock absorber may be supported on the upper stator housing by a bump stopper.

The shock absorber may operate so that its central axis moves reciprocally by being inserted through an opening formed in the upper stator housing.

A spring that supports a lower surface of the upper stator housing, supports a load of the stator housing and the vehicle, and alleviates the shock may be provided around the shock absorber.

A vehicle height adjustment device may be provided between the upper surface of the wheel hub and the lower surface of the stator housing so that rotation centers of the rotor housing and the wheel are adjusted to be aligned.

The vehicle height adjustment device may raise the vehicle to align the central axes when the central axis of the wheel is lower than the central axis of the rotor housing.

According to an embodiment of the present disclosure, by providing the wheel assembly structure including the buffer device between the in-wheel motor including the stator and the rotor, it is possible to alleviate the shock from the lower portion of the vehicle being transmitted to the in-wheel motor and strengthen the durability of the high-voltage cable connected to the in-wheel motor.

In addition, according to embodiments of the present disclosure, by applying the wheel assembly structure to the skateboard platform applied to mobility vehicles, it is possible to greatly contribute to the marketability of the mobility vehicle.

In addition, by providing the vehicle height adjustment device, it is possible to adjust the posture and ground height of the vehicle to provide getting on and off comfort and to provide a sense of stability by reducing ground height fluctuations depending on the load.

In addition, by providing the electromechanical brake (EMB) caliper for braking and connecting the brake disc to the rotor, it is possible to additionally reduce the unsprung mass and to simplify the braking structure and improve the weight since the power cables, wires, etc. connected to the braking device do not behave like the wheels.

In addition, by eliminating the drive system, integrating the motor/suspension/braking system, and applying the quick connecting structure to implement the modular structure, it is possible to reduce the assembly man-hours and contribute to activating the smart factory field.

### BRIEF DESCRIPTION OF THE DRAWINGS

FIG. 1 is a perspective view illustrating a state of a wheel assembly structure of a vehicle according to an embodiment of the present disclosure, viewed from an outer side of the vehicle.

FIG. 2 is a perspective view illustrating a state of the wheel assembly structure of a vehicle according to an embodiment of the present disclosure, viewed from an inner side of the vehicle.

FIG. 3 is a plan view illustrating a state of the wheel assembly structure of a vehicle according to an embodiment of the present disclosure, viewed from the outer side of the vehicle.

FIG. 4 is a plan view illustrating a state of the wheel assembly structure of a vehicle according to an embodiment of the present disclosure, viewed from the inner side of the vehicle.

FIG. 5 is a cross-sectional view illustrating a state of the wheel assembly structure of a vehicle according to an embodiment of the present disclosure, viewed from a front of the vehicle.

FIG. 6 is a plan view illustrating a state in which a wheel and a central axis of an in-wheel motor of the wheel assembly structure of a vehicle according to an embodiment of the present disclosure are aligned, viewed from the outer side of the vehicle.

FIG. 7 is a cross-sectional view of FIG. 6 viewed from the front of the vehicle.

FIG. 8 is a plan view illustrating a state in which the wheel and the central axis of the in-wheel motor of the wheel assembly structure of a vehicle according to an embodiment of the present disclosure are aligned, viewed from the outer side of the vehicle.

FIG. 9 is a cross-sectional view of FIG. 8 viewed from the front of the vehicle.

### DETAILED DESCRIPTION OF ILLUSTRATIVE EMBODIMENTS

Hereinafter, exemplary embodiments of the present disclosure will be described in detail with reference to the accompanying drawings so that those skilled in the art to which the present disclosure pertains may easily practice the present disclosure. However, the present disclosure may be implemented in various different forms and is not limited to the exemplary embodiments provided herein.

In addition, in several exemplary embodiments, components having the same configuration will be representatively described using the same reference numerals in an exemplary embodiment, and only components different from those of the exemplary embodiment will be described in the other exemplary embodiments.

Note that drawings are schematic and not drawn to scale. The relative dimensions and ratios of parts in the drawing are shown exaggerated or reduced in size for clarity and convenience in the drawing, and any dimensions are illustrative only and not limiting. In addition, the same reference sign is used to indicate similar features to the same structure, element, or part appearing in two or more drawings. When a part is referred to as being “on” or “over” another part, it may be directly on top of the other part, or it may be accompanied by another part in between.

Exemplary embodiments of the present disclosure specifically represent certain exemplary embodiments of the present disclosure. As a result, numerous variations of the illustration are expected. Accordingly, the exemplary embodiments are not limited to a specific form of the illustrated area, and include, for example, a deformation of the form by manufacturing.

Hereinafter, a wheel assembly structure of a vehicle according to exemplary embodiments of the present disclosure will be described in detail with reference to the accompanying drawings.

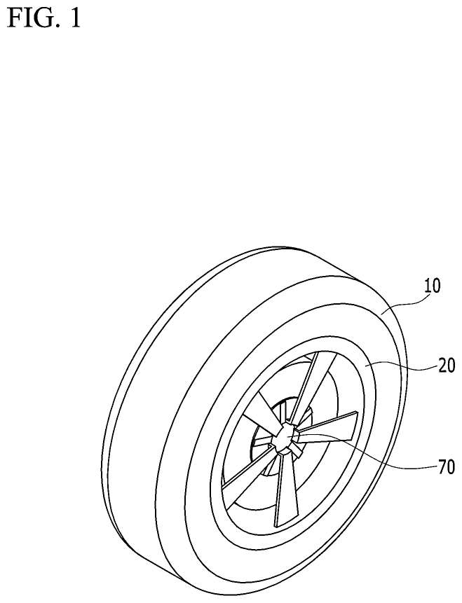

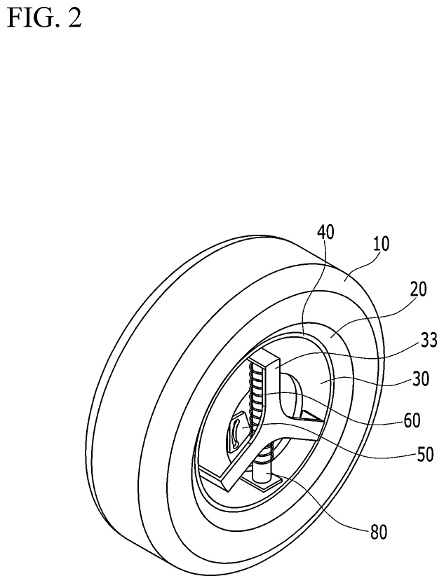

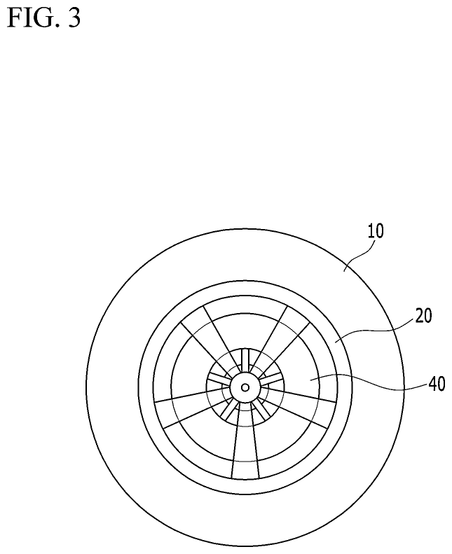

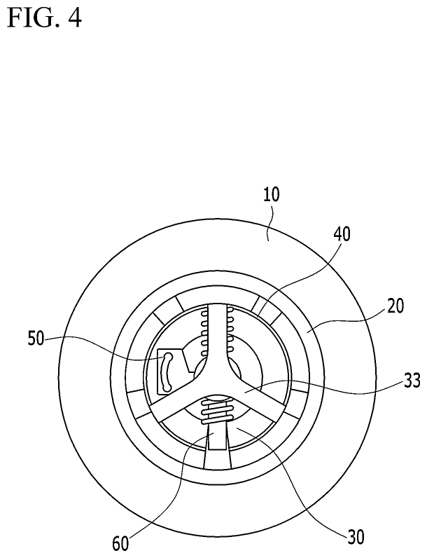

FIG. 1 is a perspective view illustrating a state of a wheel assembly structure of a vehicle according to an embodiment of the present disclosure, viewed from an outer side of the vehicle. FIG. 2 is a perspective view illustrating a state of the wheel assembly structure of a vehicle according to an embodiment of the present disclosure, viewed from an inner side of the vehicle. FIG. 3 is a plan view illustrating a state of the wheel assembly structure of a vehicle according to an embodiment of the present disclosure, viewed from the outer side of the vehicle. FIG. 4 is a perspective view illustrating a state of the wheel assembly structure of a vehicle according to an embodiment of the present disclosure, viewed from the inner side of the vehicle.

Referring to FIGS. 1 to 4, the wheel assembly structure of a vehicle according to an embodiment of the present disclosure includes a wheel 20 around which a tire 10 of the vehicle is mounted, a rotor housing 40 connected to the wheel 20, a buffer device 70 interposed between the rotor housing 40 and the wheel 20 to alleviate the shock between the rotor housing 40 and the wheel 20, and a stator housing 30 rotating the rotor housing 40 by applying a current.

The stator housing (stator) 30 and the rotor housing (rotor) 40 are provided inside the rotor 40 to form an in-wheel motor. The in-wheel motors 30 and 40 may be an electric vehicle drive system that drives wheels by directly mounting an electric motor on each wheel. Unlike a drive method using a traditional internal combustion engine and transmission, efficient energy transfer is possible because the wheels and motors are directly connected.

The wheel 20 is mainly made of metal and rotates about a central axis. The wheel 20 functions to support the tire 10, reduces shock received from the road, and supports a weight of the vehicle.

The tire 10 surrounds an outside of the wheel 20 and is mainly made of rubber and steel wire. The tire 10 may control a direction and speed of the vehicle using friction with a road surface. The tire 10 absorbs the shock from the road surface to provide a comfortable driving environment and increases vehicle safety.

The rotor 40 may be connected to the inside of the wheel 20 and may rotate together with the wheel 20. The rotor 40 is a part that receives electricity from the in-wheel motors 30 and 40 and rotates. The rotor 40 serves to transmit a rotational force of an engine to the wheels. The rotation of the rotor 40 is a primary means of converting power into mechanical energy.

The stator 30 may be fixed to the vehicle and may rotate the rotor 40 by applying a current. The stator 30 is a fixed part of the in-wheel motors 30 and 40 and may mainly be made of coils or magnets. When electrical energy passes through the stator 30, a magnetic field may be generated, and this magnetic field may rotate the rotor 40.

A bearing may be provided between the rotor 40 and the stator 30. The bearing allows a shaft to move between the rotor 40 and the stator 30 and is a part that supports the smooth rotation of the internal parts.

A buffer device 70 is provided around a central axis of the rotor housing 40. The buffer device 70 is provided between the central axis of the rotor housing 40 and a center portion of the wheel 20, and the rotor housing 40 rotates together when the wheel 20 rotates.

The buffer device 70 may be made of an elastic polymeric material. In addition, the buffer device 70 may be composed of an air spring. The buffer device 70 may be provided on an outer side of the in-wheel motors 30 and 40, that is, around an outer side of the stator housing 30. In addition, the buffer device 71 may be interposed between an upper surface of the rotor housing 40 and a lower surface of the wheel 20.

Due to the buffer device 70, the wheel 20 and the in-wheel motors 30 and 40 may move relative to each other up and down, protect the in-wheel motors 30 and 40 from lower shock, and reduce vibration.

Meanwhile, the wheel assembly structure of a vehicle according to an embodiment of the present disclosure may be applied to, for example, a purpose built vehicle (PBV). The wheel assembly structure may be modularized and applied to an underbody (skateboard) of a vehicle body of the PBV.

As illustrated in FIGS. 2 and 4, a vehicle connection part 33 may be formed on the stator housing 30 facing an inner side of the vehicle to connect the stator housing 30 to the vehicle. The stator housing 30 and the rotor housing 40 may not move relative to each other up and down and left and right.

In addition, a shock absorber 62 is provided between the wheel 20 and the stator housing 30 to alleviate the shock between the stator housing 30 and the wheel 20.

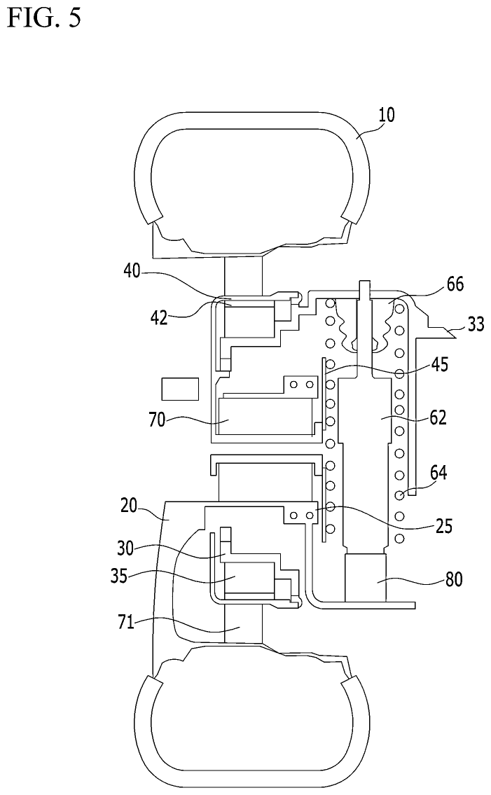

FIG. 5 is a cross-sectional view illustrating a state of the wheel assembly structure of a vehicle according to an embodiment of the present disclosure, viewed from a front of the vehicle.

Referring to FIG. 5, the central axis of the rotor housing 40 facing the inner side of the vehicle may be provided with a rotor brake disc 45. In addition, as illustrated in FIG. 4, the stator housing 30 may be provided with a caliper 50 that contacts the rotor brake disc 45 and brakes the vehicle by applying frictional force to the rotor housing 40.

Generally, in the case of the in-wheel motor, a mechanical braking device often exists in the form of the disc brake directly connected to the wheel, and the in-wheel motor itself may perform the role of regenerative braking. The braking system may be present inside the wheels or the in-wheel motor of the vehicle and may include the caliper and disc.

The caliper is a major component of the braking system and serves to reduce or stop the rotation of the wheel by applying pressure to a brake pad on the disc.

In addition, the disc is a metal plate that rotates with the wheel, and the brake pad is pressed against the disc by the caliper, which may reduce or stop the rotation of the wheel. The braking device included within the in-wheel motor may operate together with the regenerative braking to improve the braking performance and energy efficiency of the vehicle.

According to an embodiment of the present disclosure, the rotor brake disc 45 connected to the rotor 40 is used, and the braking is possible with the caliper 50 connected to the stator 30.

The caliper 50 may be an electromechanical brake (EMB) caliper. The EMB caliper 50 is an eco-friendly system that does not use hydraulic pressure at all and relies on an electrical manner, so it is also called dry type and is a complete “brake-by-wire” type.

Meanwhile, a permanent magnet 42 is provided on an inner surface of the rotor housing 40 facing the rotation axis of the rotor housing 40, and a coil 35 is provided on the outer surface of the stator housing 30 in a position facing the permanent magnet 42. When power is applied to the coil 35, the electromagnetic force is generated, thereby causing the rotor housing 40 to rotate. The rotation of the rotor housing 40 causes the wheel 20 to rotate.

A wheel hub 25 may be further formed at the central portion of the wheel 20 to extend toward the inside of the vehicle.

The shock absorber 62 may be further provided between the upper surface of the wheel hub 25 and the lower surface of the stator housing 30 to alleviate the shock between the stator housing 30 and the wheel 20. The shock absorber 62 is an example of a suspension and is installed between the stator housing 30 and the wheel 20 to absorb shock from the road surface, thereby improving ride comfort and reducing damage to the vehicle.

An upper end of the shock absorber 62 is supported on the upper stator housing 30 by a bump stopper 66. The bump stopper 66 may prevent the shock absorber 62 from directly contacting and colliding with the stator 30 and may be made of the elastic polymer material.

A central axis of the shock absorber 62 may be protruding upward, and this protruding axis may be inserted through an opening formed in the stator housing 30 and operate to reciprocate.

Meanwhile, a spring 64 may be provided around the shock absorber 62 to support the lower surface of the upper stator housing 30, support the load of the stator housing 30 and the vehicle, and alleviate the shock. The shock absorber 62 and the spring 64 together may function as the suspension of the vehicle.

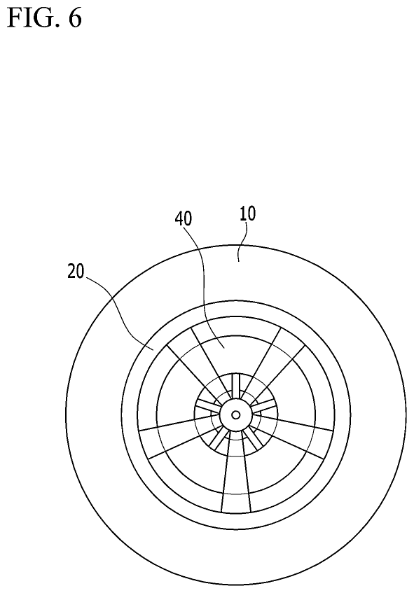

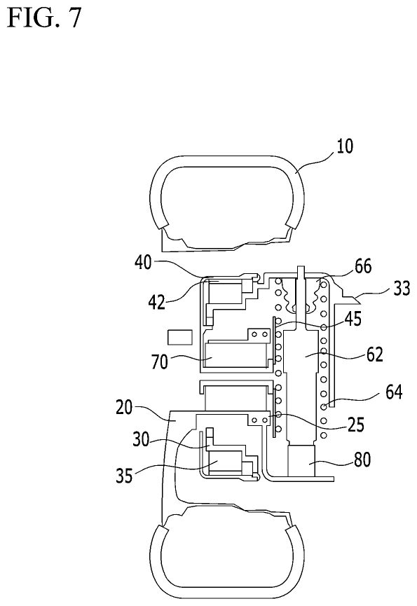

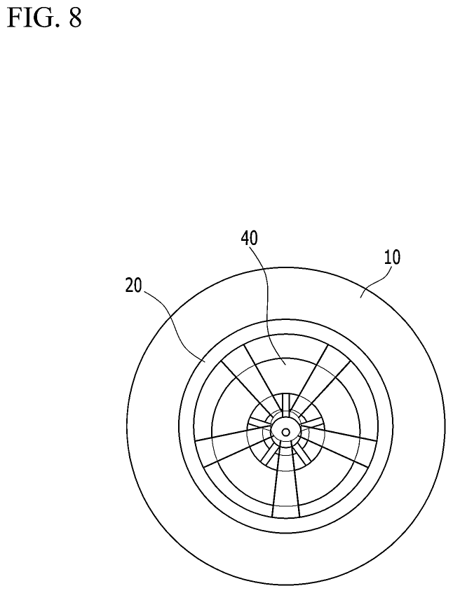

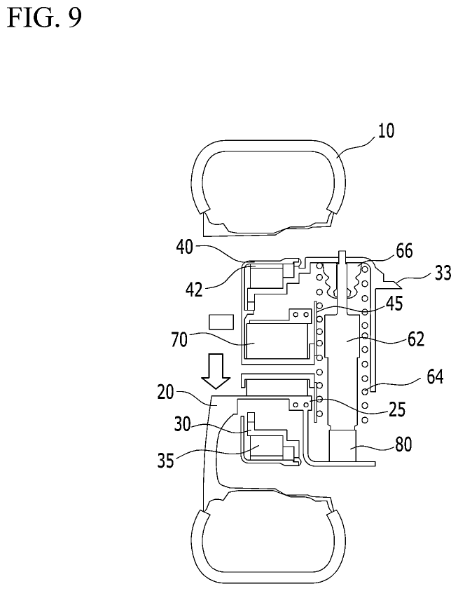

FIG. 6 is a plan view illustrating a state in which a wheel and a central axis of the in-wheel motor of the wheel assembly structure of a vehicle according to an embodiment of the present disclosure are aligned, viewed from the outer side of the vehicle. FIG. 7 is a cross-sectional view of FIG. 6 viewed from the front of the vehicle. In addition, FIG. 8 is a plan view illustrating a state in which the wheel and the central axis of the in-wheel motor of the wheel assembly structure of a vehicle according to an embodiment of the present disclosure are aligned, viewed from the outer side of the vehicle. FIG. 9 is a cross-sectional view of FIG. 8 viewed from the front of the vehicle.

FIGS. 6 and 7 are identical to the wheel assembly structure of a vehicle according to the embodiment of the present disclosure of FIGS. 3 and 5 described above. That is, FIGS. 6 and 7 illustrate the state in which the central axes of the wheel, stator, and rotor are aligned.

FIGS. 8 and 9 illustrate a case where the central axes of the wheel 20 and the stator housing 30 are lower than the central axis of the rotor housing 40. In this case, when the load of the vehicle is applied to the wheel 20 through the vehicle connection part 33, the wheel 20 and the stator housing 30 may collapse to the lower end, and the lower portion of the buffer device 70 may be compressed.

The vehicle height adjustment device 80 may be provided between the upper surface of the wheel hub 25 and the lower surface of the stator housing 30. As illustrated in FIGS. 8 and 9, when the rotation centers of the rotor housing 40 and the wheel 20 do not match to adjust the wheel 20 and the stator housing 30, the vehicle height adjustment device 80 operates momentarily to lift the wheel 20 and the stator housing 30 to the upper end, so the central axes of the wheel 20, the stator housing 30, and the rotor housing 40 are adjusted to be aligned. That is, when the central axes of the wheel 20 and the in-wheel motors 30 and 40 do not match due to the momentary lower shock while the vehicle is running, the vehicle height adjustment device 80 operates momentarily and continuously to adjust the central axes to be aligned. By adjusting the central axes to be aligned, the eccentricity of the buffer device 70 may be reduced. Accordingly, the damage to various device elements such as the in-wheel motors 30 and 40 and the buffer device 70 may be prevented, and the durability of the vehicle may be improved.

As such, according to an embodiment of the present disclosure, by providing the wheel assembly structure including the buffer device between the in-wheel motor that includes the stator and the rotor and the wheel, it is possible to alleviate the shock from being transmitted to the lower portion of the vehicle with the in-wheel motor.

In addition, according to embodiments of the present disclosure, by applying the wheel assembly structure to the skateboard platform applied to the mobility vehicles, it is possible to greatly contribute to the marketability of the mobility vehicle.

In addition, by providing the vehicle height adjustment device, it is possible to adjust the posture and ground height of the vehicle to provide the getting on and off comfort and to provide the sense of stability by reducing the ground height fluctuations depending on the load.

In addition, by providing the EMB caliper for braking and connecting the brake disc to the rotor, it is possible to additionally reduce the unsprung mass and to simplify the braking structure and improve the weight since the power cables, wires, etc. connected to the braking device do not behave like the wheels.

In addition, by eliminating the drive system, integrating the motor/suspension/braking system, and applying the quick connecting structure to implement the modular structure, it is possible to reduce the assembly man-hours and contribute to activating the smart factory field.

While this disclosure has been described in connection with what is presently considered to be practical exemplary embodiments, it is to be understood that the disclosure is not limited to the disclosed embodiments. On the contrary, it is intended to cover various modifications and equivalent arrangements included within the spirit and scope of the appended claims.

The following reference identifiers may be used in connection with the drawings to describe various features of embodiments of the present disclosure.

| | |
|---|---|
| 10: Tire | 20: Wheel |
| 25: Wheel hub | 30: Stator housing |
| 33: Vehicle connection part | 35: Coil |
| 40: Rotor housing (rotor) | 42: Permanent |
| 45: Rotor brake disk | 50: Caliper |
| 62: Shock absorber | 64: Spring |
| 66: Bump stopper | 70: Buffer device |
| 80: Vehicle height adjustment device | |

What is claimed is:

1. A wheel assembly structure of a vehicle, the structure comprising:
a wheel;
a tire mounted around the wheel;
a rotor housing connected to the wheel;
a buffer device interposed between a circumference of a central axis of the rotor housing and a central portion of the wheel or between an upper surface of the rotor housing and a lower surface of the wheel, the buffer device being configured to rotate together with the wheel and to alleviate a shock between the rotor housing and the wheel; and
a stator housing fixable to the vehicle and configured to rotate the rotor housing by applying a current.

2. The structure of claim 1, further comprising a rotor brake disc disposed at the central axis of the rotor housing facing an inner side of the vehicle.

3. The structure of claim 2, wherein the stator housing includes a caliper configured to contact the rotor brake disc and brake the vehicle by applying frictional force to the rotor housing.

4. The structure of claim 1, wherein the stator housing includes a vehicle connection part on a surface of the stator housing facing an inner side of the vehicle, the vehicle connection part being configured to connect the stator housing to the vehicle.

5. The structure of claim 4, wherein the stator housing and the rotor housing are configured to not move relative to each other up and down and left and right.

6. The structure of claim 1, further comprising:
a permanent magnet disposed on an inner surface of the rotor housing facing a rotation axis of the rotor housing; and
a coil disposed on an outer surface of the stator housing at a position facing the permanent magnet, wherein the rotor housing is configured to operate to rotate by electromagnetic force generated by applying power to the coil.

7. A wheel assembly structure of a vehicle, the structure comprising:
a wheel, wherein a central portion of the wheel includes a wheel hub extending toward an inner side of the vehicle;
a tire mounted around the wheel;
a rotor housing connected to the wheel;
a buffer device interposed between a circumference of a central axis of the rotor housing and the central portion of the wheel or between an upper surface of the rotor housing and a lower surface of the wheel, the buffer device being configured to rotate together with the wheel and to alleviate a shock between the rotor housing and the wheel; and
a stator housing fixable to the vehicle and configured to rotate the rotor housing by applying a current.

8. The structure of claim 7, further comprising a shock absorber disposed between an upper surface of the wheel hub and a lower surface of the stator housing, the shock absorber being configured to alleviate the shock between the stator housing and the wheel.

9. The structure of claim 8, further comprising a bump stopper configured to support an upper end of the shock absorber on the stator housing.

10. The structure of claim 8, wherein the shock absorber is configured to operate such that a central axis of the shock absorber moves reciprocally by being inserted through an opening in the stator housing.

11. The structure of claim 8, further comprising a spring disposed around the shock absorber, the spring being configured to support the lower surface of the stator housing, support a load of the stator housing and the vehicle, and alleviate the shock.

12. The structure of claim 11, further comprising a vehicle height adjustment device between the upper surface of the wheel hub and the lower surface of the stator housing, the vehicle height adjustment device being configured to adjust rotation centers of the rotor housing and the wheel to be aligned.

13. The structure of claim 12, wherein, in a case in which the central axis of the wheel is lower than the central axis of the rotor housing, the vehicle height adjustment device is configured to raise the vehicle to align the central axes.

14. A vehicle comprising:
a vehicle body;
a wheel coupled to the vehicle body;
a tire mounted around the wheel;
a rotor housing connected to the wheel;
a buffer device interposed between a circumference of a central axis of the rotor housing and a central portion of the wheel or between an upper surface of the rotor housing and a lower surface of the wheel, the buffer device being configured to rotate together with the wheel and to alleviate a shock between the rotor housing and the wheel; and
a stator housing fixed to the vehicle and configured to rotate the rotor housing by applying a current.

15. The vehicle of claim 14, further comprising a rotor brake disc disposed at the central axis of the rotor housing facing an inner side of the vehicle.

16. The vehicle of claim 15, wherein the stator housing includes a caliper configured to contact the rotor brake disc and brake the vehicle by applying frictional force to the rotor housing.

17. The vehicle of claim 14, wherein:
the stator housing includes a vehicle connection part on a surface of the stator housing facing an inner side of the vehicle, the vehicle connection part being configured to connect the stator housing to the vehicle; and
wherein the stator housing and the rotor housing are configured to not move relative to each other up and down and left and right.

18. The vehicle of claim 14, further comprising:
a permanent magnet disposed on an inner surface of the rotor housing facing a rotation axis of the rotor housing; and
a coil disposed on an outer surface of the stator housing at a position facing the permanent magnet, wherein the rotor housing is configured to operate to rotate by electromagnetic force generated by applying power to the coil.

19. The vehicle of claim 14, wherein the central portion of the wheel includes a wheel hub extending toward an inner side of the vehicle, and wherein the vehicle further comprises a shock absorber disposed between an upper surface of the wheel hub and a lower surface of the stator housing, the shock absorber being configured to alleviate the shock between the stator housing and the wheel.

20. The vehicle of claim 19, further comprising:
a bump stopper configured to support an upper end of the shock absorber on the stator housing;
a spring disposed around the shock absorber, the spring being configured to support the lower surface of the stator housing, support a load of the stator housing and the vehicle, and alleviate the shock; and
a vehicle height adjustment device between the upper surface of the wheel hub and the lower surface of the stator housing, the vehicle height adjustment device being configured to adjust rotation centers of the rotor housing and the wheel to be aligned.
